(19) United States
(12) Patent Application Publication
(10) Pub. No.: US 2009/0169836 A1
(43) Pub. Date: Jul. 2, 2009

(54) Polymer bonded web friction and anti-friction composites

(76) Inventor: Christopher Michael Thomas, Rocky River, OH (US)

Correspondence Address: Christopher Michael Thomas, 18403 Edgewood Drive, Rocky River, OH, 44116-2824, US

(21) Appl. No.: 12/317,576

(22) Filed: Dec. 26, 2008

Related U.S. Application Data
(60) Provisional application No. 61/008,931, filed on Dec. 26, 2007.

(51) Int. Cl. B32B 27/04; B32B 5/26; B32B 3/10; C08J 5/18

(52) U.S. Cl. 428/196; 442/381; 264/331.11

(57) ABSTRACT

Disclosed is a composite material and process for manufacture of a composite material that are used as bearings to reduce energy losses in rotating equipment and as shoes in clutches or breaks to provide increased frictional characteristics. The new and unique composite and manufacturing processes utilizes a polymer or polymer composite layer to hold nonwoven fibrous layers together during the composite manufacturing process. Additionally the bonding layer is formulated and the nonwoven fibers are treated to increase the speed and reliability of processing. The result of this and additional improvements provides large economies over the composite products and process currently in use.

### CROSS-REFERENCE TO RELATED APPLICATIONS

This application claims U.S. Provisional Application No. 61/008,931 filed on Dec. 26, 2007.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention represents a significant step forward in the field of friction control materials. Currently marketed friction and anti-friction parts sold for the purpose of slowing/stopping a moving surface or allowing unimpeded movement of a moving surface do not address the problems of high capital equipment cost, slower than achievable manufacturing rates, inability to rapidly and economically adapt manufacturing to desired results.

All friction and anti-friction materials, if properly described should be easily categorized into one of five categories, as follows; 1). Sintered metallic, 2). Molded Composite, 3). Wet-laid papermaking techniques, 4). Woven textile composite, 5). Dry-laid, wet-laid, or polymer-laid nonwoven textile composite. This latter of which will henceforth be defined “Category 5 Composites”.

The term “Bonding Layer” is herein defined as polymer resin or polymer resin composite. The term “Matrix” is herein defined as a continuous film and discontinuous island matrix. The term “Tacking” is herein defined as solidifying the Matrix to form a blanket.

The scope of this invention is specifically addressed to the production of non-woven textile employed as a raw material in the manufacture of friction and anti-friction composites, and therefore discussion of all other friction and anti-friction material prior art not employing non-woven textile composites are beyond the scope of this invention and are not addressed herein.

2. Description of Related Art

Prior art within the arena of friction and anti-friction non-woven textile composite materials is extremely limited from a patent and public record perspective. The following art is representative of what is published.

U.S. Pat. No. 5,646,076 and U.S. Pat. No. 5,989,375 to inventor Bortz discloses a friction controlling device that has a low wear rate, non-abrasive operational characteristics and unique construction materials. However, the disclosure of inventor Bortz lacks a solution to the problems of slow production speed, high production cost, inability to rapidly and economically adapt manufacturing to desired results largely due to the application of the needle-punching as the sole means to bind fibrous webs into a unitary structure or blanket, which is then employed as the fibrous starting material to produce friction or anti-friction composite.

U.S. Pat. No. 6,835,448 to inventor Menard discloses a friction material that has a stable frictional coefficient in lubricated environments, improved resistance to heating and stability at high operational pressures. However, the disclosure of inventor Menard lacks a solution to the problems of slow production speed, high production cost, inability to rapidly and economically adapt manufacturing to desired results, which like Bortz, is largely due to the application of the needle-punching as the sole means to bind fibrous webs into a unitary structure or blanket, which is then employed as the fibrous starting material to produce friction or anti-friction composite.

U.S. Pat. No. 5,646,880 to inventor Ronyak discloses a annular filamentary structure that has a simplified method of substrate manufacture. However, the disclosure of inventor Ronyak lacks a solution to the problems of slow production speed, high production cost, inability to rapidly and economically adapt manufacturing to desired results once again due largely to the application of the needle-punching as the sole means to bind fibrous webs into a unitary structure or blanket, which is then employed as the fibrous starting material to produce friction or anti-friction composite.

U.S. Pat. No. 5,609,770 to inventor Bazshushtari discloses a carbon/carbon composite that has a novel method of allowing recycling of scrap raw materials. Carbon vapor deposition (CVD) and equivalents thereof or saturation with a resin transformable into carbon at high temperature is employed to fill voids between the fibers, forming a composite. Although the inherent efficiency gains of employing a rotary needle-punch loom compared to a flat needle-punch board are described. However, the disclosure of inventor Bazshushtari lacks a solution to the problems of slow production speed, high production cost, inability to rapidly and economically adapt manufacturing to desired results once again due largely to the application of the needle-punching as the sole means to bind fibrous webs into a unitary structure or blanket, which is then employed as the fibrous starting material to produce friction or anti-friction composite.

Further U.S. Pat. No. 3,950,599 to Board, Jr. describes a low friction laminate liner for bearings which employs a needle-punched non-woven textile backing material bonded to an anti-friction fluoro-polymer surface material. This non-woven backing material is not engaging any moving surfaces, and therefore the non-woven component is irrelevant from a prior art perspective concerning this invention.

None of the above patents or Published patent applications singly or in combination is seen to describe the present invention as claimed.

### BRIEF SUMMARY OF THE INVENTION

The present invention is a composite for friction and anti-friction applications. Generally, the instant invention solves the problem of expensive production by allowing significant improvements in line speed, reduced capital machinery expense and reduced labor costs. In addition to solving these problems added features that allow process parameters to be rapidly adjusted to decrease labor required to perform manufacturing adjustments, decrease capital equipment cost for manufacturing adjustments, decrease capital equipment downtime for manufacturing adjustments, decreased rate of machinery malfunction and decreased labor to remedy machinery malfunctions are also provided.

The preferred embodiment of the present invention provides additional unique features by providing unique ability to contour/profile inter-laminar properties within the z-axis thickness of the composite material, allow discreet covert incorporation of product identification tracers and allow maximum flexibility of desired manufacturing parameters to optimize varying product applications.

The primary objective of the present invention is to reduce manufacturing costs associated with prior art.

A further objective of the present invention is to apply advanced features allowing more manufacturing flexibility than possible using prior art.

It is an objective of the present invention to reduce manufacturing cost provide more efficient manufacture of a non-woven textile unitary structure or blanket by reducing labor cost and tooling cost associated with mechanical techniques of bonding fibrous webs into said unitary structure or blanket, thereby reducing overall raw material cost (RMC).

It is a further objective of the present invention to improve ease of processing, performance and create a competitive edge by incorporating new manufacturing techniques to provide the ability to optimize desired physical and non-physical properties which were previously unattainable when employing mechanical techniques to bond fibrous webs into a unitary structure or blanket.

It is a feature of the present invention to further reduce cost by employing easily applied bonding layers to bond multiple layers of fibrous webs together into a non-woven textile unitary structure or blanket to reduce labor cost and tooling cost associated with mechanical techniques of bonding said fibrous webs into said unitary structure or blanket, thereby reducing overall raw material cost (RMC).

it is a further feature of the present invention to reduce cost and ease further processing by employing bonding layers which are easily varied in surface coverage percent to quickly modify stiffness or hand of the resulting unitary structure or blanket with reduced labor and tooling costs associated with employing said modifications upon mechanical entanglement web bonding machinery.

It is a further feature of the present invention to reduce cost, ease further processing and allow tailored properties of finished products when the top, bottom and center layer are the friction surface by employing new manufacturing techniques by incorporating a mask similar to silk-screening used in the printing industry, or electrostatic methods to selectively deposit bonding layers in a pre-determined pattern onto multiple layers of fibrous webs being bound together into a non-woven unitary structure or blanket to optimize desired physical properties while minimizing raw material cost (RMC).

It is a further feature of the present invention to reduce cost, ease further processing and allow tailored properties of finished products when the top, bottom and center layer are the friction surface by employing new manufacturing techniques by incorporating a mask similar to silk-screening used in the printing industry, or electrostatic methods to selectively deposit chemical treatments in a pre-determined pattern to attract or repel later application of bonding layers onto multiple layers of fibrous webs being bound together into a non-woven unitary structure or blanket to optimize desired physical properties while minimizing raw material cost (RMC).

It is a further feature of the present invention to create a competitive edge over prior art by employing new manufacturing techniques by incorporating product identification tracers into Bonding Layer bonding layers in discrete and covert ways which are difficult to detect, duplicate or reverse engineer to optimize desired non-physical properties of said unitary structure or blanket.

### BRIEF DESCRIPTION OF THE SEVERAL VIEWS OF THE DRAWING(S)

FIG. 1: Is a top view of the continuous film matrix.

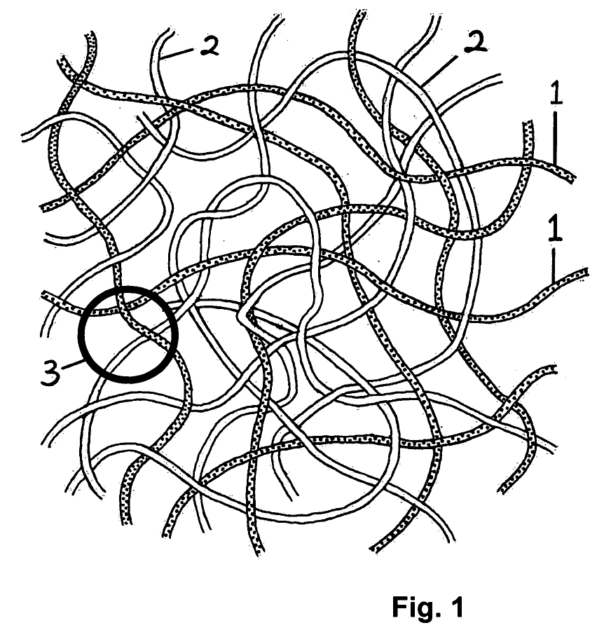

FIG. 2: Is a top view of the discontinuous island matrix.

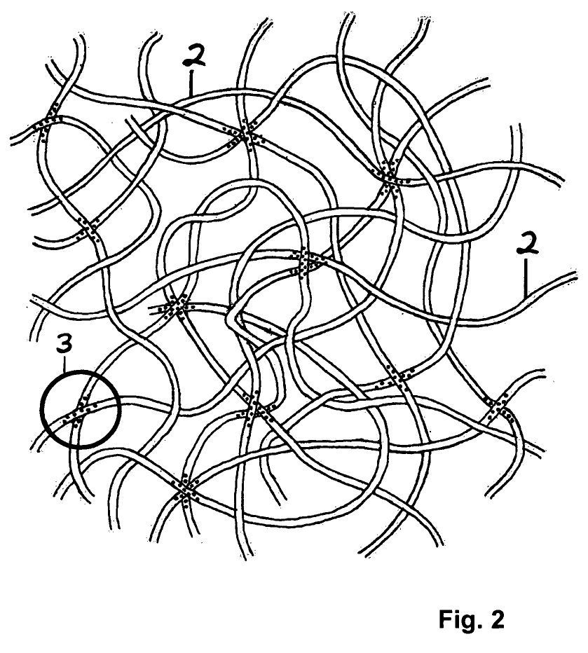

FIG. 3: Is a block diagram of the process of the preferred embodiment.

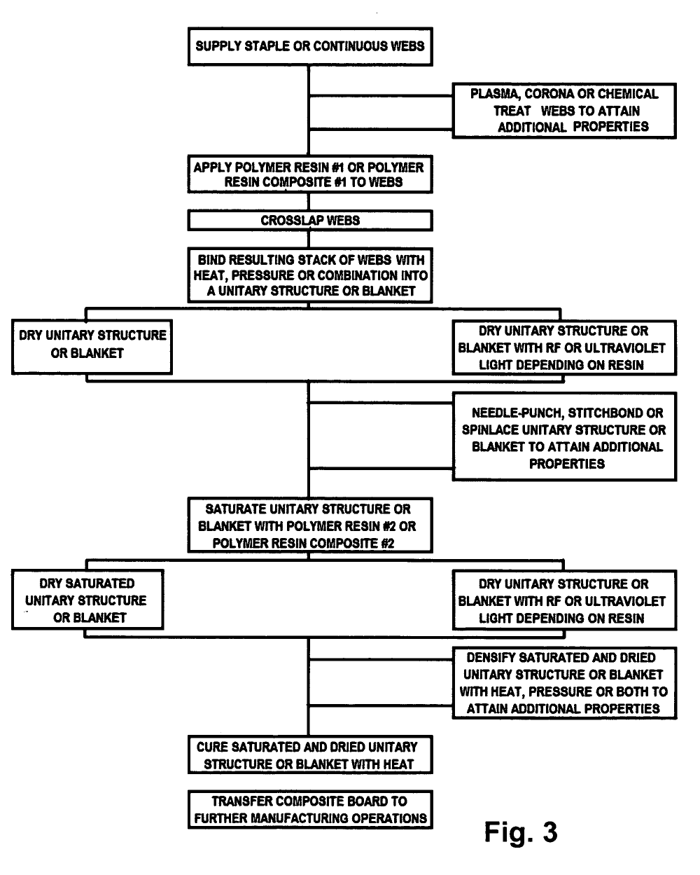

### DETAILED DESCRIPTION OF THE INVENTION

The present invention is a composite for friction and anti-friction applications. Generally, the instant invention solves the problem of expensive production by allowing significant improvements in line speed, reduced capital machinery expense and reduced labor costs. In addition to solving these problems added features that allow process parameters to be rapidly adjusted to decrease labor required to perform manufacturing adjustments, decrease capital equipment cost for manufacturing adjustments, decrease capital equipment downtime for manufacturing adjustments, decreased rate of machinery malfunction and decreased labor to remedy machinery malfunctions are also provided.

The preferred embodiment of the present invention provides additional unique features by providing unique ability to contour/profile inter-laminar properties within the z-axis thickness of the composite material, allow discreet covert incorporation of product identification tracers and allow maximum flexibility of desired manufacturing parameters to optimize varying product applications.

The present invention includes a friction or anti-friction composite raw material comprised of fibrous webs held together into a unitary structure, or blanket, without the need for mechanical bonding methods, such as needle-punching, stitch-bonding or spunlaced hydro-entanglement textile techniques.

The present invention makes use of Bonding Layer, either in a Matrix, to bond a plurality of webs together into a unitary structure or blanket which is employed as an application-specific raw material used in the manufacture of nonwoven based friction and anti-friction products, and has commercially important advantages to offer the friction and anti-friction industries, and also friction and anti-friction product consumers, as follows; 1). Lower cost of manufacture because of increased line speed compared to needle-punched or spunlaced hydro-entanglement nonwoven production techniques, 2). No possibility of broken or pulled steel needles from a needle-loom or needle-board becoming embedded in the unitary structure or blanket, avoiding abrasive spots in finished friction or anti-friction composite when manufacturing a product advertised as non-abrasive, 3). Maximum control of the percentage of web surfaces bonded together without time-consuming tooling changes, 4). Ability to quickly customize and profile the amount of individual interlaminar web bonding properties required from the unitary structure or blanket for each particular friction or anti-friction application the material is intended for, 5). Maximum control of raw-material-cost (RMC) and cost versus benefit ratio for each friction or anti-friction application by adjusting the Bonding Layer formula and percentage of surface coverage of the Matrix, 6). Using product identification tracers in the Matrix polymer resin composite gives the ability to discretely and covertly hide product identification tracers within the interlaminar structure of the overall friction or anti-friction composite, keeping them hidden from the eye of others, and making said product identification tracer technologies more difficult to detect, duplicate, or reverse engineer, 7). Ability to accurately control stiffness, or what is referred to as “hand” in the textile industry, of the unitary structure or blanket by adjusting the formulation and percentage of the Matrix Bonding Layer to provide best results using widely varied manufacturing machinery and methods, 8). Ability to quickly change application technique (for example changing from powder spraying to powder sprinkling) in the event of malfunctioning application equipment applying the Matrix where no replacement part for the present application technique is immediately available, thus avoiding costly downtime. The same cannot be said if you break your last needle-board or needle-roll in a needle-punching operation and do not have another replacement part immediately available, 9). Ability to customize the absorption profile of said unitary structure or blanket perpendicular to the plane of the blanket in the Z-axis thickness direction by manipulating percentage and pattern of surface coverage of said Matrix independently for each individual web layer, allowing controlled amounts of Bonding Layer to enter each respective web layer upon saturation of the overall unitary structure or blanket, based upon the principle of volumetric displacement. Increased volume percentage of Matrix within some web layers forming the unitary structure or blanket will reduce the volume of Bonding Layer allowed to enter these respective webs during subsequent saturation of the overall unified structure or blanket, and likewise, decreased volume percentage of Matrix within other web layers will produce the opposite effect. Ability to manipulate such interlaminar Matrix Bonding Layer to saturation Bonding Layer ratios can be beneficial by allowing the outer surface of the overall friction or anti-friction composite to contain larger percentages of less expensive Matrix Bonding Layer, because the outermost surface will be machined away in subsequent manufacturing operations, thereby lowering overall raw-material-cost (RMC). This technique will also allow the lowest web layers of the overall friction or anti-friction composite located closest the bonding interface with the pad, disc or shoe core, typically made of steel or other materials, to be adjusted to provide optimum physical properties for best possible adhesion and other desirable properties at the bonding interface, such as flexure. Such profiling of interlaminar properties is not possible with any mechanical bonding techniques such as needle-punching, stitch-bonding or spunlaced hydro-entanglement techniques.

The present Invention, depending upon polymer type and polymer solvent selected, and whether or not photo-initiators are incorporated, said Bonding Layer forming the Matrix may be cured or dried quickly in a continuous process using conveyorized ultraviolet light curing or conveyorized radio frequency drying techniques if curing or drying is required of the selected polymer type to solidify the Matrix of the unitary structure or blanket prior to proceeding further in the manufacturing process.

### Web-Bonding Matrix Resins

The present invention employs a relatively diverse set of possible polymer resins to be used alone or in compatible mixtures, and may be used to formulate polymer resin composite to form the Matrix bonding said webs together. The reason for such a diverse set of polymer types is because this invention may employ such a diverse set of fiber types, and is capable of producing a friction composite raw material which is application-specific for almost any intended friction application manufacturing process.

THERMOPLASTICS may include acrylic, ethylene vinyl acetate (EVA), polyamide, polyamide-imide (PAI), polyimide, polyethylene, polypropylene, polyester, vinylester, polycarbonate, polyvinyl chloride (PVC), polyaryl ether, polyetherimide, and polyphenyl sulfide.

Polyamide (nylon) may include low molecular weight nylons such as polycaprolactone and polycaprolactan. These have the lowest melting points of any thermoplastics are particularly useful to bond webs of fibers which are heat sensitive, and to generally minimize heat cycle process times with any fiber type, thereby maximizing line speed.

Polyethylene may include maleated polyethylene waxes, oxidized polar polyethylene waxes, and metallocene polyethylenes. These all have low melting temperatures which are generally desirable for web bonding purposes to keep heating cycle times to a minimum, and prevent damage to some fiber types.

Polypropylene may include high molecular weight polypropylene.

Polyester may include polybutylene terephthalate (PBT) and cyclic polybutylene terephthalate (CBT). Although CBT may be employed as the only resin, the high cost of CBT may prohibit this for economic reasons. CBT flows extremely well upon melting, with very low viscosity. Also, tin catalyst may be employed with CBT to break open the cyclic molecular structure upon melting to transform CBT into PBT. However, the cyclic CBT resin also is useful as a rheological flow enhancer when used as a minor additive in conjunction with other compatible polymers, and is therefore also listed within the section on rheology modifiers in this invention. Typical use of CBT as a flow enhancer ranges from about 1 to 10 percent by weight of CBT powder blended with other polymer powders.

Some thermoplastics may be blended with heat-sensitive cross-linkers to render them thermosets.

ELASTOMERS may include natural rubber, polybutadiene, polyisoprene, polyurethane elastomers, polysulfide polymers, polychloroprene, ethylene-propylene copolymers, ethylenepropylene-diene terpolymers, chlorosulfonated polyethylene, and plasticized polyvinylchloride.

THERMOPLASTIC ELASTOMERS may include styrene-butadiene (SB), styrene-isoprene (SI), styrene-butadiene-styrene (SBS), styrene-isoprene-styrene (SIS), styrene-ethylene/butylene (SEB), styrene-ethylene/propylene (SEP), styrene-ethylene/butylene-styrene (SEBS), and styrene-ethylene/propylene-styrene (SEPS).

THERMOSETS may include acrylic, melamine, phenolic, polyamide, polyamide-imide (PAI), polyimide, polyester, vinylester, and urethane.

Phenolic may include resol water emulsion (SPhG).

Some factors to be considered when selecting polymer resin types to be employed as the Matrix polymer resin or to formulate polymer resin composite employed as either said matrix include temperature resistance, thermal conductivity, abrasion resistance, composition of opposing surface, abrasivity upon opposing surface, chemical and environmental resistance, compatibility with other polymer resins in a mixture, compatibility with fiber types to be used, compatibility with powder or small fiber modifiers to be included in formulating a polymer resin composite, application ease and efficiency, temperature required for complete melt, sharpness of melt point or narrowness of melt range, desired thickness of unitary structure or blanket, time duration of heating cycle required for complete melt in central core of unitary structure or blanket, storage stability of polymer resin raw materials, viscosity of melted solids in liquid state, viscosity of solids dissolved in solvent, strength and tenacity of bonding upon selected fiber types, wetting action upon selected fiber types, ease of equipment cleanup, ease of fabrication, amount of waste created in fabrication, disposal restrictions on polymer resin waste and associated solvents, health hazards of polymer resins and associated environmental controls, health hazards of solvents employed in liquid polymer resin systems and associated environmental controls, flammability hazards of fine powders and associated controls, flammability of solvents employed in liquid polymer resin systems and associated controls, commercial availability of desired grades, stability and reliability of supply chains, raw-material-cost (RMC), marketability of friction product produced, place and price point of friction product within the overall friction market, anticipated sales volume of friction product, and anticipated profit margin on sales. The later of these are business-oriented goals, as opposed to technical-oriented goals, but can affect the polymer resin types selected nevertheless.

### Fibers

The present invention employs a relatively diverse set of possible fibers to form said webs. The reason for such a diverse set of fiber types is because this invention is capable of producing a friction composite raw material which is application-specific for almost any intended friction application manufacturing process.

Polymer fibers, natural plant fibers, natural animal fibers, glass fibers, natural mineral fibers, man-made mineral fibers (MMMF), ceramic fibers, metallic fibers, semi-metallic fibers, carbon fibers, and carbon fiber precursors may all be successfully employed in this invention. These nonwoven webs may be composed of short-chop fibers, staple fibers longer than one-half inch in length, or tows of continuous fibers. Staple fibers are preferred because of their ease of processing into nonwoven webs.

Polymer fibers, which may include, aramid fibers, novoloid fibers, polybenzimidazole (PBI) fibers, polyamide fibers, and fluoropolymer fibers.

Natural plant fibers, which may include hemp fibers, cotton fibers, jute fibers, coconut fibers, sisal fibers, ramie fibers, kenauf fibers, flax fibers, banana leaf fibers, and abaca fibers.

Natural animal fibers, which may include wool.

Glass fibers, which may include E-glass and S-glass.

Natural mineral fibers, which may include wollastonite.

Man-made mineral fibers (MMMF), which may include rockwool.

Ceramic fibers.

Metallic fibers, which may include copper, copper alloys, aluminum, aluminum alloys, and steel.

Semi-metallic fibers, which are metal-coated plastic, plastic-coated metal, and a core completely covered by metal.

Carbon fibers.

Carbon fiber precursors, which may include polyacrylonitrile (PAN) fiber, oxidized polyacrylonitrile fiber (OPF), and novoloid fiber.

Some factors to be considered when selecting fiber types to be employed include temperature resistance, thermal conductivity, abrasion resistance, composition of opposing surface, abrasivity upon opposing surface, chemical and environmental resistance, compatibility with other fibers in a mixture, compatibility with polymer resin to be used, compatibility with powder or small fiber modifiers incorporated into polymer resin to be used, ease of fabrication, affinity of bonding to selected resin types, ability to be easily wetted by selected polymer resin type, amount of fiber waste created in fabrication, disposal restrictions on fiber waste, health hazards and associated environmental controls, flammability hazards and associated controls, commercial availability of desired grades, stability and reliability of supply chains, raw-material-cost (RMC), marketability of friction product produced, place and price point of friction product within the overall friction market, anticipated sales volume of friction product, and anticipated profit margin on sales. The later of these are business-oriented goals, as opposed to technical-oriented goals, but can affect the fiber types selected nevertheless.

Natural plant and animal fibers make use of “green technologies” for friction applications. Natural plant and animal fiber nonwoven textiles commercially available to date are all bonded using mechanical entanglement techniques. No effort in the natural textile industry has focused upon binding said webs of natural fibers together using polymer bonded web techniques using Bonding Layer, and the many advantages such polymer bonded web techniques offer beyond those of mechanical entanglement techniques, such as needle-punching and spunlaced hydro-entanglement techniques.

### Powder Application of Web-Bonding Matrix Resins

Although application of said Matrix Bonding Layer may be accomplished using almost any logical method, the preferred method of application for discontinuous island matrix Bonding Layer is using electrostatic powder spray techniques. Commercially available equipment is available from Nordson Corporation (Westlake, Ohio, USA).

The preferred embodiment of said Bonding Layer powders used to produce said discontinuous island matrix is for direct electrostatic application on the carding line after producing a carded web, with or without pre-heating of said web, and with or without post-heating the applied powder, but prior to crosslapping. Because polymer resin powder or polymer resin composite powder is applied to only one side of the fibrous web prior to crosslapping, upon crosslapping, the respective alternating pockets of crosslapped web now alternate between being rich in powder content for one crosslap web pocket and being deficient in powder content for the next successive crosslap web pocket. However, the end of the crosslapping line is incorporated with heaters (preferably in the form of a convection tunnel oven with impingement airflows for relatively thick blanket thickness, or an array of infrared heaters for relatively thin blanket thickness, depending on the overall thickness of webs being bonded) to pre-melt all polymer resin powder or polymer resin composite powder used in said discontinuous island matrix to a temperature greater than the melting point of such powders within the internal core of the web blanket, and then the output of said crosslapping line proceeds directly into heated calendar rolls to maintain heat and produce sufficient pressure to force an equilibrium of molten powder islands between the alternating resin-rich and resin-deficient crosslap web pocket zones, resulting in uniform interlaminar bonds between all web layers within the resulting unitary structure or blanket.

The advantages of using electrostatic powder application techniques over other methods include the following;

No application messy liquids, foams, pastes or gels is required. These can gum-up the carding line and require periodic cleaning from machinery. Electrostatic powders can be easily removed from carding line and crosslapping line machinery using vacuum or compressed air.
No need to dry solvent used in liquids, foams, pastes or gels prior to crosslapping the treated webs. This saves time, capital machinery expense, electricity consumption, and eliminates associated safety and environmental concerns regarding volatile solvent emissions.
No need to pre-bond webs to a film prior to crosslapping, or to insert film into web crosslaps. This is a relatively slow procedure which a given film thickness can easily place somewhat more or less polymer resin between the webs than is needed to achieve the desired interlaminar web bonding strength. In-situ changes of polymer resin quantity for a particular production run often requires using a film of another thickness, which requires additional raw materials inventory for films of differing thickness. Also, polymer resin composite of custom formulation is not easy or economical to produce into a film.
Powder retains electrostatic attraction to webs during the crosslapping process, and does not fall away during the crosslapping process as with powders applied by gravity sprinkling techniques.

Successful use of electrostatic powder techniques requires that the selected polymer resin or formulated polymer resin composite must be relatively dry, and must be presented to the powder spray or fluidized bed application apparatus in the form of powders with a particle size distribution profile suitable for the powder application equipment used. Such polymer materials may be available in suitable form which is ready-to-use as supplied, or may need to be milled and classified for particle size prior to use. Fiber or particulate modifier components used to formulate said polymer resin composite will likely need to be pre-dispersed in a liquid solution of the selected polymer resin, and subsequently spray-dried into a powder, or otherwise solidified into larger solids which can subsequently be milled into a powder. Although many milling techniques may be employed to reduce larger size Bonding Layer materials to powder, the preferred milling technique employs cryogenic milling using a rotary hammer mill, of the swinging-hammer type, with nitrogen cooling gas. Rotary hammer mills are generally the most efficient and economical mill types for the widest variety of cryogenic fine-milling applications, although disc mills and jet mills generally have the ability to cryogenically mill even finer particle sizes for any given material, with jet mills being the finest. In cryogenic milling, a supply of cooling gas is necessary within the hammer mill to keep internal mill temperatures sufficiently low to prevent subject Bonding Layer from fusing within the mill, and to maintain milling temperatures below the glass transition temperature (Tg) of the Bonding Layer being milled. Subsequent screen classification to remove oversize particles may be employed using various rotary, vibratory or air classification techniques. Even at cryogenic milling temperatures, polymers with friable or brittle mechanical properties can be milled to smaller particle sizes than polymers with flexible or resilient mechanical properties. The most efficient mill type depends upon the type of material being milled, and the desired particle size. The desired or optimum particle size of a given polymer material may not be economically or physically achievable. For example, some of the more resilient polymers, such as low melting temperature metallocene polyethylenes, polyethylene waxes, polypropylene waxes, elastomers, thermoplastic elastomers, and low molecular weight nylons such as polycaprolactones and polycaprolactans may be difficult to cryogenically mill to a particle size below about 60 mesh (250 micrometers), which is relatively large, and may require multiple types of mills to be employed in succession. Other more friable polymers may easily be milled to incredibly small particle sizes beyond the smallest ASTM standard sieve size of 635 mesh (20 micrometers) by employing only a hammer mill. There are no easy generalized rules about mill or classification equipment selection, and all depends upon the type and specific properties of material being milled, particle size desired, and narrowness of particle size distribution profile desired.

Spray-dried powders, which are Bonding Layer dissolved in solvent as a liquid and subsequently spray-dried is also possible to be usefully employed in this invention, but such techniques are also limited on attainable particle size without employing additional milling and classification, depending upon the polymer resin selected, and the type and size of any fine fibers or particulates employed as modifiers in formulating said polymer resin into a polymer resin composite.

Contract toll-milling and classification services are also available from companies such as Prater Industries (Bolingbrook, Ill., USA), CCE Technologies (Cottage Grove, Minn., USA), ICO Polymers (Asbury, N.J., USA), and Aveka, Inc. (Saint Paul, Minn., USA). Prater and CCE also manufacture various types of mills and classifiers. Given the broad possibilities of commercially available polymer resins which may be successfully employed in this invention for said discontinuous island matrix, contract toll-processing can be a very economical alternative to be considered carefully because toll-processors have diverse expertise in milling and particle size classifying of almost infinitely varied materials, and the proper machinery to most efficiently do so.

Typical powders for electrostatic application are typically in the 10 to 30 micrometer range, which means the particles will pass through at least 450 mesh screen (32 micrometer), and possibly as fine as 635 mesh screen (20 micrometer) ASTM standard sieve sizes. Finer particle sizes are attainable for some relatively friable polymers, possibly down to 5 micrometers or less, but these cannot be classified by screen because 635 mesh is the finest ASTM screen size available, and therefore such powders must be air-classified.

Powder application to non-electrically conductive webs of most polymer fibers typically require what is known in the powder industry as a “tribo gun” for successful powder application, wherein a triboelectric charge is imparted due to the nature of the gun construction materials, and the velocity and force of particle impact upon such gun materials. Typically, polyamide (nylon) or fluoropolymer (Teflon, PTFE) spray gun construction materials will inherently impart the desired charge necessary for sprayed powders to be attracted to various non-electrically conductive webs. In the case of spraying polyethylene powder, a gun constructed of nylon would be used.

Electrically conductive webs of most metallic and carbon fibers can have powder successfully applied with traditional corona (powered) or tribo (non-powered) powder spray equipment.

Many factors will determine how the electrostatic powder web-coating process is most successfully and efficiently completed. Variables include particle size distribution profile and electrical conductivity properties of the selected polymer resin powder or formulated polymer resin composite powder, electrical conductivity properties of the fibrous web said powder is being applied to, temperature of fibrous webs, air pressure supplied to the powder spray gun or fluidized bed, feed rate of powder supply feeder, gun spray pattern, distance between gun and target web surface, quality of cathode (negative ground) connection to surfaces supporting the web, materials web supporting surfaces are constructed of, electrostatic voltage potential imparted upon the powder particles within the corona (powered) or tribo (non-powered) spray apparatus, and the option of heating the powder coated webs on the carding line after powder application to melt applied powder onto said webs, thereby preventing said powders from falling off in the subsequent crosslapping process, although additional heating after crosslapping will be required to bond crosslapped webs into a unitary structure or blanket. Virtually any dry polymer compound of proper particle size, regardless of electrical conductive properties, or a lack thereof, may be applied using electrostatic powder methods at the relatively short application distances used herein.

The aforesaid effect of web temperature upon powder retention efficiency is an interesting aspect of said electrostatic powder deposition techniques. Webs slightly pre-heated, but below the melting temperature of the polymer resin powder or polymer resin composite powder, will exhibit greater powder retention, with less corresponding overspray loss of powder to other non-web machine and plant areas when compared to relatively cooler ambient temperature webs.

The present invention is intended to produce a relatively thick unitary structure or blanket which requires bonding many layers of webs using a Matrix composed of Bonding Layer. Powders applied directly to webs are of a polymer type designed to be melted to cause bonding of said webs by formation of a discontinuous island matrix, and therefore the time required to obtain a uniform and homogeneous heat profile throughout the entire blanket thickness to obtain uniform melting of said matrix polymers will increase as blanket thickness increases, and is a function of time, temperature, blanket thickness, blanket density, airflow velocity, and airflow profile. In the case of a tunnel oven on the crosslapping line, the function of time may be increased by either slowing the system line speed or increasing the length of the heated zone. The other remaining aforesaid factors may be adjusted also. Temperature, pressure, and speed of heated calendar rolls which the unitary structure or blanket enters upon exiting the crosslapping line oven must also be considered and adjusted carefully to obtain the desired results.

Any suitable Bonding Layer may be applied to said webs as a powder to form a discontinuous island matrix, or said powder may be dissolved in a suitable solvent to form a solution for coating, spraying or dipping said webs, evaporating said solvent from said web coating, and thereby used to create a continuous film or discontinuous island matrix. A wide variety of meltable polymer resins within the thermoplastic, elastomer, and thermoplastic elastomer polymer groups are commercially available, and may be successfully processed and employed for subject powders and other application methods. The type of meltable polymer resin selected for use as a web bonding matrix material in general, and for producing powders specifically, should be selected from polymer types which melt at reasonably low temperatures to facilitate rapid and efficient melting, and to keep melt temperatures below the temperature compatibility of the fibers composing the fibrous webs being bonded into the unitary structure or blanket. Fibers types with relatively high temperature compatibility are generally non-meltable, and may allow selection of almost any meltable polymer resin deemed to be chemically compatible with the fibers and economically feasible for production of the desired unitary structure or blanket. Fiber types which are meltable require careful selection of only polymer resins having very low melting temperatures to avoid melting the fibers during the web bonding process.

Polyethylene powders are among the most economical from a raw-material-cost (RMC) perspective, and will generally have lower melting temperatures than polypropylene powders. Many polyethylene powders have melting temperatures as low as about 95 degrees C. or about 203 degrees F.

One manufacturer of cryogenically ground thermoplastic polyethylene (PE) and polypropylene (PP) polymer powders is Innotek, LLC (Big Springs, Tex., USA). The powders they offer are typically below 212 micrometers (pass 70 mesh screen ASTM standard sieve size), but smaller custom milled sizes are available.

Polymer resins of the thermoplastic elastomer family which are commercially available and well suited for this application include several polymer groups and chemical family designations. Many of these polymers contain molecules composed of combinations of block segments of styrene (thermoplastic) monomer units and rubber (elastomer) monomer units in various ratios and molecular arrangements, thus are classified in the broadest sense as thermoplastic elastomers. Some examples are styrene-butadiene (SB), styrene-isoprene (SI), styrene-butadiene-styrene (SBS), styrene-isoprene-styrene (SIS), styrene-ethylene/butylenes (SEB), styrene-ethylene/propylene (SEP), styrene-ethylene/butylene-styrene (SEBS), and styrene-ethylene/propylene-styrene (SEPS). The later 2 groups (SEBS and SEPS) generally have higher melting temperatures than the others as general classes. One commercially available polymer within the SIS group with exceptionally low melting temperature range is Kraton D1162BT available from Kraton Polymers, LLC (Houston, Tex., USA).

Flame spray is also an alternative technique of powder coating. This involves blowing the employed Bonding Layer powder through a propane flame so as pre-melted liquid droplets are delivered to the target surface, similar to electrostatic application of liquid paints, except without solvent. Alternatively, flame spray techniques may be employed by flame spraying said Bonding Layer powder at a temperature slightly below the melting point of the powder, and pre-heating the target web surface to a temperature above the melting point of said powder, whereby said powder melts rapidly upon contact with said target web surface. For some other applications, the advantage of flame spray techniques is that no post-heating is required to melt the powder, allowing substrates that will not tolerate heat well, such as wood, to be coated in a solvent-free manner. However, the present invention requires the plurality of webs to be bonded simultaneously into a unitary structure or blanket after crosslapping. Therefore, even if flame spray were used to deposit the subject discontinuous island matrix of Bonding Layer upon subject webs on the carding line, heat would still be required after crosslapping to re-melt the discontinuous island matrix and thereby affect a bond between the plurality of crosslapped web layers to produce the desired unitary structure or blanket. As a result, heat upon the crosslapped stack of webs will be required for electrostatic powders to produce the desired web-bonding results in producing a unitary structure or blanket, regardless of how the powder is conveyed to the webs, liquid or solid. Some disadvantages of flame spray techniques are the relatively large amounts of overspray loss of sprayed material, and the relatively large amounts of polymer burned and thereby consumed by the flame.

### General Production Issues

The melting temperature of Bonding Layer employed to form said Matrix is of importance to reduce the length of heating time required to melt such materials within subject webs to increase production speed and reduce associated machinery size and capital expense. This is also important if bonding webs of meltable fibers, where Bonding Layer forming the Matrix must melt well below the melting temperature of the web fibers. The melting temperature of some low molecular weight nylons, such as polycaprolactones and polycaprolactans are lower than any other useable materials able to form said Matrix, and melt as low as about 55 to 60 degrees C. or about 131 to 140 degrees F., with exceptionally sharp melting points. The melting temperature ranges of all other useable polymers for creating the Matrix will be higher than the aforementioned low molecular weight nylons, but many other polymer types are commercially available with relatively low melting temperatures. Some examples of relatively low melting temperature polymers are metalocene polyethylenes, polyethylene waxes, polyethylene powders, and some thermoplastic elastomers. The melting temperature range of thermoplastic elastomers can vary greatly, depending on the molecular block configuration and the thermoplastic to elastomer block ratio, and will always be a relatively broad temperature range, without a sharp melting point. Polyethylene powders have melting temperatures as low as about 95 degrees C. or about 203 degrees F., which may be below the melting temperature of some webs composed of meltable fibers. Other webs composed of non-meltable fibers may employ virtually any meltable Bonding Layer which has a melting temperature below temperatures which may damage or decompose said web fibers. As can be seen, carefully selected melting temperatures of polymers employed for the polymer resin or to formulate polymer resin composite have implications concerning viability and efficiency of the web bonding process, whether applied dry as a powder to create a discontinuous island matrix, or dissolved in a suitable solvent to form a solution suitable to spray or dip said webs, evaporating said solvent from said web coating, and thereby used to create a continuous film or discontinuous island matrix. This later technique is not generally as desirable because it adds additional steps to the manufacturing process, and raises other concerns such as environmental VOC emissions, toxicity, and flammability. Similar solvent techniques may also be employed to create gels, foams, or pastes of Bonding Layer which may also be successfully employed.

For the intended friction composite application, the interlaminar bond strength between said webs comprising the resulting unitary structure, or blanket is of little importance once said unitary structure, or blanket is subsequently saturated with other Bonding Layer and dried to form a rigid composite board. Only sufficient interlaminar bond strength between said webs of the unitary structure, or blanket to hold said webs together during the subsequent saturation and drying process is required.

The interlaminar strength of the webs which compose the resulting unitary structure or blanket is greatly influenced by many factors, such as the type of web fiber selected, type of polymer resin selected, modifiers selected if polymer resin was formulated into a polymer resin composite, volumetric percentage of Bonding Layer employed, pattern and uniformity of Matrix application to the web surfaces, and if only one side of the crosslapped webs had Bonding Layer applied, the efficiency of melt flow, fiber wetting, and pressure applied by heated calendar rolls to affect good penetration of melted material through the webs in resin-rich crosslap pockets into adjacent resin-deficient crosslap pockets. Because the intent of the present invention is to subsequently saturate the resulting unitary structure or blanket with other Bonding Layer, or for subsequent carbon vapor deposition (CVD) to produce a rigid composite board suitable for manufacturing friction control devices, it is desired that the unitary structure or blanket maintain sufficient flexibility and porosity to facilitate subsequent saturation or carbon vapor deposition (CVD) while simultaneously providing sufficient temporary interlaminar strength between the webs to facilitate such subsequent blanket saturation or carbon vapor deposition (CVD). The temporary interlaminar strength provided to the resulting unitary structure or blanket must also be able to withstand the forces applied in ruled-edge die cutting, whereby the unitary structure or blanket is pre-cut to the desired shape or preform prior to saturation with other Bonding Layer, or subjected to carbon vapor deposition (CVD).

### Modifiers

Modifiers and their Applications;

The general term MODIFIERS are classified herein as friction modifiers, thermal conductivity modifiers, rheology modifiers, product identification tracers, fillers, and colors. Nano-materials have been incorporated into the aforementioned 6 groups according to their useful functionality (if any) when said modifiers are used as additives to the selected polymer resin for the purpose of formulating a polymer resin composite. The present invention employs a relatively diverse set of possible modifiers to be used alone or in compatible mixtures, and may be incorporated into said polymer resin to formulate a polymer resin composite employed to form the Matrix bonding said webs together. The reason for such a diverse set of modifier types is because this invention may employ such a diverse set of fiber types, polymer resin types, and is capable of producing a friction composite raw material which is application-specific for almost any intended friction application manufacturing process.

FRICTION MODIFIERS are employed to manipulate the frictional coefficient higher or lower as desired to obtain the desired frictional properties in a friction or anti-friction material. Anti-friction materials are designed to reduce frictional coefficient as low as possible within the desired temperature range. Friction materials are designed to increase and maintain frictional coefficient to a desired level within the desired temperature range. In the case of fiber-resin composites, the inherent frictional coefficient of a pure fiber-resin system without friction modifiers and within the desired temperature range is governed by the fiber type, resin type, fiber to resin ratio, and density of the composite. Although frictional coefficient of the overall pure fiber-resin system may be considered, often such fibers and resins are selected upon specific criterion, such as abrasion resistance, raw material cost (RMC), manufacturing cost, efficiency of manufacturing, and abrasiveness of the composite upon opposing frictional surfaces. Such fiber and resin selection does not often yield a composite with the desired frictional coefficient. It is almost always desirable to adjust this inherent frictional coefficient of the selected pure fiber-resin system either higher or lower, depending upon the intended product application. Friction modifiers, usually and most easily incorporated into the resin component of the fiber-resin composite system, are what allows this inherently limited window of frictional coefficient to become a much more dynamically modified window of frictional coefficient possibilities for a given fiber-resin system. The term FRICTION MODIFIERS as used herein are small particulates of about 500 microns or less in diameter, or small fibers of about 1 millimeter or less in length, or combinations thereof, which are incorporated into said polymer resin to formulate a polymer resin composite employed to form the disMatrix intended to bond subject webs together. Particulates or fibers employed as friction modifiers are sub-classified under the following sub-groups for simplicity; nano-materials, carbon materials, polymer materials, semi-metallic materials, metallic materials, metal soaps, natural materials, very hard man-made materials, and micro-spheres. NANO-MATERIALS are defined as carbon nano-fibers, single-wall carbon nano-tubes, multi-wall carbon nano-tubes, nano-clay and nano-silica. CARBON MATERIALS are defined as graphite, calcined petroleum coke, carbon black, and carbon fiber. POLYMER MATERIALS are defined as natural rubber, synthetic rubber, polyamide, olefins including polyethylene and polypropylene, and fluoropolymer. SEMI-METALLIC MATERIALS are defined as metal-filled fluoropolymer (more than 50% fluoropolymer), fluoropolymer-filled metal (more than 50% metal), metal-coated plastic, plastic-coated metal, or a core completely covered by metal. METALLIC MATERIALS are defined as copper, copper alloys, lead, lead alloys, tin, tin alloys, antimony, antimony alloys, iron, and steel. METAL SOAPS are defined as aluminum stearate, calcium stearate, lithium stearate, magnesium stearate, zinc stearate. NATURAL MATERIALS are defined as mica, feldspar, calcium carbonate (limestone), clay, wollastonite, diatoms, silica, aluminum oxide (corundum) (Al2O3), zinc oxide (ZnO), barium sulfate (BaO4S), molybdenum disulfide (MoS2), and lead sulfide (galena) (PbS). VERY HARD MAN-MADE MATERIALS are defined as chromium carbide (Cr2C2), chromium oxide (Cr2O3), molybdenum carbide (Mo2C), tantalum carbide (TaC), tantalum niobium carbide (TaNbC), titanium boride (TiB2), titanium nitride (TiN), titanium carbide/nitride (TiCN), tungsten carbide (WC), tungsten sulfide (WS2), tungsten titanium carbide (WTiC), tungsten tantalum carbide (WTaC), tungsten titanium tantalum carbide (WTiTaC), boron carbide (B4C), hexagonal boron nitride (HBN), and silicon carbide (SiC). MICRO-SPHERES are defined as glass micro-spheres (derived from flyash or man-made), and resol micro-spheres.

THERMAL CONDUCTIVITY MODIFIERS are employed to manipulate thermal conductivity higher or lower as desired, although increasing thermal conductivity is typically the intended goal. In a friction material such as a brake or clutch assembly, or an anti-friction material such as a journal bearing or thrust bearing, it is typically desirable to transfer frictionally created heat away from the friction surface, into lower layers of the friction material, and most preferably completely out of the friction material by transferring such heat into other core materials which support the friction or anti-friction facing. In the case of fiber-resin composites, the inherent thermal conductivity of a pure fiber-resin system without thermal conductivity modifiers is governed by the fiber type, resin type, fiber to resin ratio, and density of the composite. Although thermal conductivity of the overall pure fiber-resin system may be considered, often such fibers and resins are selected upon specific criterion, such as abrasion resistance, raw material cost (RMC), manufacturing cost, efficiency of manufacturing, and abrasiveness of the composite upon opposing frictional surfaces. Such fiber and resin selection does not often yield a composite with the desired thermal conductivity. It is almost always desirable to adjust this inherent thermal conductivity of the selected pure fiber-resin system either higher or lower, depending upon the intended product application. Thermal conductivity modifiers, usually and most easily incorporated into the resin component of the fiber-resin composite system, are what allows this inherently limited window of thermal conductivity to become a much more dynamically modified window of thermal conductivity possibilities for a given fiber-resin system. The term THERMAL CONDUCTIVITY MODIFIERS as used herein are small particulates of about 500 microns or less in diameter, or small fibers of about 1 millimeter or less in length, or combinations thereof, which are incorporated into said polymer resin to formulate a polymer resin composite employed to form the disMatrix intended to bond subject webs together. Particulates or fibers employed as thermal conductivity modifiers are sub-classified under the following sub-groups for simplicity; nano-materials, carbon materials, metallic materials, and semi-metallic materials. NANO MATERIALS are defined as carbon nano-fibers, single-wall carbon nano-tubes, multi-wall carbon nano-tubes, nano-clay and nano-silica. CARBON MATERIALS are defined as graphite, calcined petroleum coke, carbon black, and carbon fiber. METALLIC MATERIALS are defined as copper, copper alloys, and iron. SEMI-METALLIC MATERIALS are defined as metal-coated plastic, plastic-coated metal, or a core completely covered by metal.

RHEOLOGY MODIFIERS are used to selectively control the flow of liquid components within a liquid system. This includes solids which are subsequently melted to become liquids temporarily. Viscosity is only one form of rheology modification. Other methods of rheology modification include components possessing thixiotropic properties, whereby the thixiotropically modified liquid will decrease in viscosity upon being mixed or otherwise mechanically agitated, then increase in viscosity upon standing unagitated. Such thixiotropic cycle is infinitely repeatable, whereby further mixing of said liquid will decrease viscosity again, and upon further standing unagitated will increase viscosity again. The term RHEOLOGY MODIFIERS as used herein are small particulates of about 1 millimeter or less in diameter, or small fibers of about 1 millimeter or less in length, or combinations thereof, which are incorporated into said polymer resin to formulate a polymer resin composite employed to form the Matrix intended to bond subject webs together. Particulates or fibers employed as rheology modifiers are sub-classified under the following sub-groups for simplicity; thixiotropic materials, and non-thixiotropic materials. THIXIOTROPIC MATERIALS are defined as silica fume and bentonite clay. NON-THIXIOTROPIC MATERIALS are defined as cyclic polybutylene terephthalate (CBT), other clays, cellulose ethers, natural gums, synthetic gums, polymers, and nano-materials.

PRODUCT IDENTIFICATION TRACERS are used to identify a product from similar products of others or counterfeit products. When properly employed, product identification tracers can be a powerful tool to screen for similar products appearing in the marketplace, and to determine false warranty claims when competing products of others similar in appearance are submitted for warranty claims. Physical particles/flakes which are visually identifiable, pH sensitive materials which produce a color change upon exposure to reagents within the activation pH range, and ultraviolet tracers which fluoresce when exposed to UV-A ultraviolet light (black light) are the most commonly used tracer types. Biometric tracers exist, but are presently very expensive. The preferred tracers for this embodiment of the present invention are ultraviolet tracers. The term PRODUCT IDENTIFICATION TRACERS as used herein are small particulates of about 1 millimeter or less in diameter, or small fibers of about 2 millimeters or less in length, or combinations thereof, which are incorporated into said polymer resin to formulate a polymer resin composite employed to form the Matrix intended to bond subject webs together. Particulates or fibers employed as product identification tracers are sub-classified under the following sub-groups for simplicity; ultraviolet materials, pH sensitive materials, and colored particles or fibers. ULTRAVIOLET MATERIALS are defined as any material which fluoresces when exposed to ultraviolet light. PH SENSITIVE MATERIALS are defined as any material which produces a color change when exposed to an acidic or alkaline reagent. COLORED PARTICLES OR FIBERS are defined as any particle or fiber which is uniquely identifiable by color, size and shape.

FILLERS can be classified as either functional fillers or non-functional fillers. Any of the modifiers described in this invention, including friction modifiers, thermal conductivity modifiers, rheology modifiers, and colors can technically be defined as functional fillers. Functional fillers must serve some useful purpose other than purely being employed to reduce raw-material-cost (RMC) by displacing volume or weight of a more expensive ingredient with an equal volume or weight of a less expensive ingredient. Non-functional fillers are employed only for the purpose of reducing RMC. For purposes of this invention, the term fillers is used in the pure sense of the word to mean non-functional fillers, while functional fillers have been classified and expanded upon otherwise. The term FILLERS as used herein are intended to refer to non-functional fillers solely used to reduce raw-material-cost (RMC) by displacing volume of a more expensive material with a less expensive material. All other groups of modifiers herein (friction modifiers, thermal conductivity modifiers, rheology modifiers, product identification tracers, and colors) are sometimes referred to as “functional fillers” because they act as fillers by consuming volume, but serve some secondary useful purpose in the product besides reducing RMC. These are small particulates of about 500 micrometers or less in diameter, or small fibers of about 1 millimeter or less in length, or combinations thereof, which are incorporated into said polymer resin to formulate a polymer resin composite employed to form the Matrix intended to bond subject webs together. Particulates employed as fillers are not sub-classified in this description, and are defined simply as mica, clay, feldspar, calcium carbonate, and ground silica.

COLORS are used in many commercial products to impart uniqueness to a specific brand of product, and in trademark law this topic falls under the topic of “trade dress”. A product of unique color which is not inherent to the material itself is unique and identifiable to the customer purchasing the product. Red, yellow, or blue colored pigments, or combinations thereof, may be employed in this invention and applied upon, or otherwise incorporated into, said fibers, said Bonding Layer, or a combination thereof to impart a unique color to a fiber composite friction product that would inherently be another color. The term COLORS as used herein are small pigment particulates of about 500 microns or less in diameter which are incorporated into said polymer resin to formulate a polymer resin composite employed to form the Matrix intended to bond subject webs together. Particulate pigments employed as colors are sub-classified in this description within the scope of the associated Provisional Patent Application, and defined under the following sub-groups for simplicity; natural pigments, and synthetic pigments. NATURAL PIGMENTS are defined as any natural pigment. SYNTHETIC PIGMENTS are defined as any synthetic pigment.

### Surface Treatments

Surface treatments may be employed on fibers either before or after forming said fibers into webs, and before or after forming said webs into a unified structure, or blanket. The desired overall purpose is to facilitate good adhesion and even wetting of Bonding Layer in the areas where Bonding Layer is applied. This includes a discontinuous island matrix where the applied Bonding Layer is not intended to coat a continuous film across the entire fiber or web surfaces, and only intended to provide improved adhesion and wetting properties upon said fibers or webs at the deposited island locations. Said surface treatments may also be employed to treat the small fibers or particulates mixed with said polymer resin to formulate a polymer resin composite employed for continuous film matrix, discontinuous island matrix, or saturation of unitary structure, or blanket.

Properly selected surface treatments have the ability to clean most organic contaminants from the target surfaces by oxidation, or by ablation with ions, free radicals, and electrons. An example is fiber “sizings” often employed to aid textile processing.

Properly selected surface treatments have the ability to increase surface energy of the target surfaces by incorporating chemically reactive sites onto the surfaces, and thereby increase wetting ability of the surface.

Properly selected surface treatments also have the ability to functionalize the target surfaces by incorporating chemically reactive bonding sites onto the surfaces.

Plasma treatment, corona treatment, and chemical treatment, or combinations thereof may be employed as said surface treatment methods.

PLASMA TREATMENT is defined as an electrically charged chamber through which a stream of air or other gasses are blown onto the desired target surface to be treated.

CORONA TREATMENT is defined as an electrical discharge arc through which a stream of air or other gasses are blown onto the desired target surface to be treated.

CHEMICAL TREATMENT is defined as oxidizers such as sodium hypochlorite, hydrogen peroxide, and ozone applied to the target surface to be treated.

Plasma treatment may be conducted within a vacuum atmosphere, or at atmospheric pressure.

Gases employed for plasma or corona treatment in place of air (if any) will vary depending on composition of target surface being treated, and the type of functional groups desired to be incorporated.

I claim:

1. A process for economical manufacture of composite material used for controlling the frictional properties between relatively moving surfaces, comprising the steps:
supplying a first nonwoven fibrous layer;
supplying one or more second nonwoven fibrous layers;
applying a bonding layer to the first nonwoven fibrous layer;
forming a nonwoven textile by tacking the first nonwoven fibrous layer to one or more of the one or more second nonwoven fibrous layers using heat, pressure or both heat and pressure;
applying saturation resin to the nonwoven textile to displace void volume and become a saturated nonwoven textile;
drying the saturated nonwoven textile with heat, radio frequency or both heat and radio frequency to form a composite board;
compressing the composite board to reduce porosity, resulting in a densified composite board;
curing the densified composite board, resulting in a finished composite material;
wherein the one or more of the bonding layers is a polymer resin or polymer resin composite;
wherein the saturation resin is a polymer resin or polymer resin composite;

2. The process of claim 1, wherein:
wherein one or more of the first nonwoven fibrous layer or second nonwoven fibrous layers have been treated to enhance wetting by the bonding layer and or polymer resin or polymer resin composite.

3. The process claim 2, wherein:
the bonding layer is applied in a continuous film matrix;
The process claim 2, wherein:
the bonding layer is applied in a discontinuous pattern;

5. The process claim 3, wherein:
the bonding layer is a polymer resin composite that contains one or more of a fiber modifier, particulate modifiers, or combinations of a fiber modifier or particulate modifiers.

6. The process claim 4, wherein:
the bonding layer is a polymer resin composite that contains one or more of a fiber modifier, particulate modifiers, or combinations of a fiber modifier or particulate modifiers.

7. The process claim 3, wherein:
the bonding layer contains rheology modifiers to provide increased speed of wetting and provide more uniform wetting upon surfaces of the first nonwoven fibrous layer or second nonwoven fibrous layers.

8. The process claim 4, wherein:
the bonding layer contains rheology modifiers to provide increased speed of wetting and provide more uniform wetting upon surfaces of the first nonwoven fibrous layer or second nonwoven fibrous layers.

9. The process claim 3, wherein:
the bonding layer contains nano-materials.

10. The process claim 4, wherein:
the bonding layer contains nano-materials.

11. The process claim 3, wherein:
the bonding layer contains photo-initiators to render the bonding layer curable using ultraviolet light.

12. The process claim 4, wherein:
the bonding layer contains photo-initiators to render the bonding layer curable using ultraviolet light.
The process claim 3, wherein:
the saturating resin is applied in a liquid form to fill void volume.
The process claim 4, wherein:
the saturating resin is applied in a liquid form to fill void volume.

15. The process claim 3, wherein:
the saturating resin is vapor deposited to fill void volume.

16. The process claim 4, wherein:
the saturating resin is vapor deposited to fill void volume.

17. The process of claims 13, 14, 15 and 16 further comprising the step:
charring to form a carbonized finished material.

18. The process claim 9, wherein:
vapor deposition is carbon vapor deposition.
A composite material used for controlling the frictional properties between relatively moving surfaces, comprising:
a first nonwoven fibrous layer;
one or more second nonwoven fibrous layers;
a bonding layer separating the first nonwoven fibrous layer from one or more of the one or more second nonwoven fibrous layers;
a saturation resin filling the inter-fiber volume of the first nonwoven fibrous layer and the one or more second nonwoven fibrous layers;
wherein the one or more of the bonding layers is a polymer resin or polymer resin composite;
wherein the saturation resin is a polymer resin or polymer resin composite.
The composite material of claim 9, wherein:
the bonding layer is in a discontinuous pattern.
The composite material of claim 8, wherein:
the bonding layer is a polymer resin composite that contains one or more of a fiber modifier, particulate modifiers, or combinations of a fiber modifier or particulate modifiers.
The composite material of claim 19, wherein:
the bonding layer is a polymer resin composite that contains one or more of a fiber modifier, particulate modifiers, or combinations of a fiber modifier or particulate modifiers.
The composite material of claim 8, wherein:
the bonding layer contains nano-materials.
The composite material of 8, wherein:
the bonding layer contains photo-initiators.
